(19) United States
(12) Patent Application Publication
(10) Pub. No.: US 2024/0200713 A1
(43) Pub. Date: Jun. 20, 2024

(54) Fuel Line Comprising Insulation, and Pressure Vessel System

(71) Applicant: Bayerische Motoren Werke Aktiengesellschaft, Muenchen (DE)

(72) Inventor: Klaus SZOUCSEK, Zirndorf (DE)

(21) Appl. No.: 18/286,141

(22) PCT Filed: Apr. 6, 2022
(86) PCT No.: PCT/EP2022/059058

§ 371 Date: Oct. 9, 2023

(30) Foreign Application Priority Data
Apr. 30, 2021 (DE) 10 2021 111 173.0

(51) Int. Cl. F16L 59/147; B60K 15/03; F02M 21/02; F16L 9/00

(52) U.S. Cl. CPC F16L 59/147; B60K 15/03006; F02M 21/0221; F02M 21/0242; F02M 21/0245; F16L 9/00

(57) ABSTRACT

A pressure vessel system for a motor vehicle for storing fuel includes a plurality of pressure vessels that are combined to form a pressure vessel assembly. The pressure vessels, when mounted, are arranged substantially in parallel relative to one another, and the pressure vessels are fluidically interconnected via a common fuel line. The technology further relates to a fuel line comprising thermal insulation.

### BACKGROUND AND SUMMARY

A pressure vessel system having a pressure vessel assembly for a motor vehicle for storing fuel is known from the prior art. The aim is to dispose the fuel stores of a motor vehicle in the underfloor region below the passenger cabin. For this purpose, the installation space requires new pressure vessel systems which provide a plurality of small pressure vessels instead of a few large pressure vessels. The objective here is to accommodate as much fuel as possible in the available installation space without this having a noticeable adverse effect on the costs, the weight, or other construction parameters. Such a pressure vessel system is known from patent application with the application number DE 10 2021 106 038.9 filed by the applicant. In practice, there is a requirement for the fuel in the individual pressure vessels to have substantially identical or similar fuel temperatures after fueling.

It is a preferred object of the technology disclosed here to minimize or eliminate at least one disadvantage of a known solution, or to propose an alternative solution. It is in particular a preferred object of the technology disclosed herein to provide a storage concept that is cost-effective, lightweight and/or conforms to the installation space and in which the fuel in the individual pressure vessels has substantially identical or similar temperatures after fueling. Further preferred objects may be derived from the advantageous effects of the technology disclosed herein. The object(s) is/are achieved by the subject matter of the independent claim. The dependent claims represent preferred design embodiments.

The technology disclosed herein relates to a pressure vessel system for a motor vehicle (e.g., passenger motor vehicles, motorcycles, commercial vehicles). The pressure vessel system serves for storing fuel that is gaseous at ambient conditions. The pressure vessel system can be used, for example, in a motor vehicle which is operated using compressed natural gas (CNG) or liquefied natural gas (LNG), or using hydrogen. The pressure vessel system is fluidically connected to at least one energy converter which is specified to convert the chemical energy of the fuel into other forms of energy. The energy converter can be, for example, an internal combustion engine or a fuel cell system, or a fuel cell stack, respectively.

Such a pressure vessel system typically comprises a plurality of pressure vessels, preferably composite overwrapped pressure vessels. The pressure vessels can be, for example, high-pressure gas vessels. High-pressure gas vessels are configured to permanently store fuel at a nominal working pressure (NWP) of at least 350 bar over atmospheric pressure or at least 700 bar over atmospheric pressure at ambient temperatures. A cryogenic pressure vessel is suitable for storing the fuel at the aforementioned working pressures even at temperatures that are significantly (e.g., more than 50 K or more than 100 K) below the operating temperature of the motor vehicle.

The motor vehicle can comprise a plurality of pressure vessels. A pressure vessel assembly (also referred to as “container assembly”) can preferably comprise the pressure vessels as well as supporting, fastening and/or protecting elements (for example, protective shields, guards, barrier layers, covers, coatings, wrappings, etc.) which are permanently connected to the pressure vessels. The supporting, fastening and/or protecting elements can expediently be disassembled only temporarily and preferably only by skilled personnel and/or not in a non-destructive manner. Such a pressure vessel assembly is particularly suitable for flat installation spaces, in particular in the underfloor region below the interior of the vehicle. A pressure vessel assembly preferably comprises more than 3, or more than 5, or more than 7, or more than 10 pressure vessels. In the installed position in the motor vehicle, the pressure vessels can be oriented in the vehicle transverse direction or in the vehicle longitudinal direction.

The pressure vessels may have circular or oval cross sections. The individual pressure vessels can be configured as storage tubes. For example, a plurality of pressure vessels of which the longitudinal axes run mutually parallel in the installed position can be provided. The individual pressure vessels can in each case have a length-to-diameter ratio of between 5 and 200, preferably between 7 and 100, and particularly preferably between 9 and 50. The length-to-diameter ration is the quotient of the overall length of the individual pressure vessels (e.g., overall length of a storage tube without fluidic-connection elements) in the numerator and the largest external diameter of the pressure vessel in the denominator. The individual pressure vessels can be disposed so as to be directly adjacent to one another, for example at a mutual spacing of less than 20 cm, or less than 15 cm, or less than 10 cm, or less than 5 cm.

The technology disclosed herein furthermore relates to a fuel line for a pressure vessel system of a motor vehicle, in particular for the pressure vessel system disclosed herein. The fuel line comprises a wall. The wall is specified to compensate all the mechanical loads which result from the internal pressure prevalent in the fuel line. A thermal insulation is advantageously provided in the interior of the wall.

The fuel line expediently serves at least for fueling the pressure vessel system, in particular for filling the at least one pressure vessel. In one preferred design embodiment, the fuel line, or at least the interior of the wall, is configured so as to be substantially straight. The interior of the wall thus serves in particular for providing the fuel duct through which the fuel flows during fueling and optionally also during retrieval of the fuel.

The wall of the fuel line is typically made of metal, preferably of steel, stainless steel, or aluminum, or an alloy thereof. During operation, an internal pressure, which is many times higher than atmospheric pressure, may be prevalent in the interior of the fuel line. This pressure differential causes mechanical loads in the wall of the fuel line, e.g., mechanical stresses, which are compensated by the wall of the fuel line. To this end, the wall may even be reinforced. The wall is typically produced from metal and is of a sufficient thickness. The wall is preferably specified to withstand internal pressures which are higher than the nominal operating pressure by a factor of 2, or a factor of 2.5, or a factor of 3. However, the thermal insulation disclosed herein may not be specified to compensate the mechanical loads. The wall is preferably specified to compensate at least 90% of the mechanical loads, whereas the thermal insulation may compensate less than 10% of the mechanical loads. The wall is typically an external wall which delimits the fuel line from the atmosphere, for example in the form of a line or a solid block.

The wall can expediently be formed by a metallic block in which at least one fuel duct is incorporated, for example by drilling. The block is preferably produced from a light metal, preferably from aluminum or an aluminum alloy. The diameter of the fuel duct, and thus the internal cross-sectional area or the interior of the wall, is expediently chosen such that the fuel duct is able to be produced in one machining procedure, in particular by material subtraction and preferably by drilling.

The thermal insulation disclosed herein is typically specified to reduce the thermal transfer between the fuel and the wall. It can be ensured in this way that the fuel is heated to a lesser extent when making its way into the pressure vessel during fueling. The insulation expediently decreases the thermal transfer between the fuel and the atmosphere (or the thermal flow between the fuel and the wall) by at least 10%, or at least 15%. The insulation may be expediently formed by a polymeric material, polytetrafluoroethylene (PTFE) being preferably used. Polymeric materials have the advantage that they are comparatively good thermal insulators; moreover, assembling is simplified. Furthermore, the risk of shavings being created during assembling is reduced. It is likewise imaginable that a metallic material may form the insulation, in particular the pipe disclosed herein. In one preferred design embodiment, the insulation surrounds the primary flow duct through which the majority of the fuel, or all of the fuel, flows. In one particularly preferable design embodiment, the insulation extends substantially across the entire length of the fuel line. In this way, the thermal transfer can advantageously be reduced in almost all cross sections of the fuel line such that the fuel temperature differs to a lesser extent in the various pressure vessels of the pressure vessel system.

In one expedient design embodiment, at least one pipe conjointly forms the thermal insulation. The pipe may have any suitable cross-sectional geometry and wall thickness. The wall thickness of the insulation, and in particular of the pipe, can be less than the wall thickness of the wall by at least a factor of 2, or by a factor of 5, or by a factor of 10. The pipe can have a wall thickness of 0.1 mm to 3 mm, or of 0.2 mm to 2 mm, or of 0.2 mm to 1 mm, or of approx. 0.2 mm, or approx. 0.5 mm, or approx. 0.8 mm. The pipe is expediently configured as a thin-walled pipe in comparison to the wall. The pipe is preferably configured as a pipe which is insertable into the interior of the wall. This may simplify the production process.

At least one gap for thermal insulation can preferably be provided at least in regions between the wall and the pipe. In one design embodiment, the gap is configured as an annular gap which completely surrounds the pipe. The gap spaces apart the pipe from the internal wall of the wall at least in regions. In this way, the thermal transfer between the pipe and the wall is noticeably compromised, in particular when there is substantially stationary fuel (typically hydrogen) located in the gap. The gap expediently has a gap width between 0.05 mm and 10 mm, or between 0.1 mm and 8 mm, or between 0.15 mm and 5 mm, or between 0.20 mm and 2 mm, or approx. 0.1 mm, or approx. 0.5 mm, or approx. 1 mm.

The ratio of the internal cross section of the pipe in the numerator to the cross-sectional area of the gap in the denominator is expediently at least 1.5, or at least 2, or at least 5, or at least 10, or at least 15, or at least 27.

The pipe at least in regions can expediently be permeable to fuel in such a manner that the pressure in the gap and the pressure in the interior region of the pipe at least approximate one another.

In one design embodiment, the pressure differential between the pressure in the gap compared to the pressure in the interior region of the pipe of the same cross section of the fuel line in some or all cross sections of the fuel line, at least during fueling and preferably also during retrieval, is less than 20%, or less than 10%, or less than 5%, of the pressure in the interior region of the pipe. The maximum pressure differential between the pressure in the gap compared to the pressure in the interior region of the pipe of the same cross section of the fuel line in some or all cross sections of the fuel line, at least during fueling and preferably also during retrieval, is preferably less than 2 bar, or less than 1 bar, or less than 0.5 bar. Owing to flow resistances in the fuel line, the pressure in the fuel line decreases continuously in the flow direction. Therefore, the aforementioned pressure differentials between the gap and the interior region relate in each case to cross sections which are exposed to the same pressure loss because said cross sections are at the same distance from the fuel source.

The pressure differential between the pressure in the gap compared to the pressure in the interior region of the pipe which arises at least during fueling is advantageously so minor that the pipe does not expand, or expands only to such an extent that the pipe does not touch the wall outside the contact regions. In this way, the thermal transfer toward the wall is not compromised. The permeability to fuel can be implemented by at least one passage, or at least one opening, through which the fuel can flow into the gap. Other design embodiments are also conceivable.

In one design embodiment, holes for the passage of the fuel are provided in the pipe, between the gap(s) and the interior region of the pipe. The overall area of all holes in the pipe wall (for the pressure equalization between the interior of the pipe and the gap) can advantageously account for between 5% and 40%, or between 10% and 30%, or between 15% and 25%, of the overall area of the internal wall of the pipe.

During fueling, the flow rate of the fuel in the at least one gap can be lower during fueling than in the interior of the pipe by a factor of at least 10, or by a factor of at least 100, or by a factor of at least 1000. In one preferred design embodiment, the fuel is substantially at a standstill during fueling.

The pipe can have at least one contact region in which the pipe bears on the wall. In the other regions, with the exception of the contact region, the pipe can be spaced apart from the wall by the at least one gap. In this way, the regions in which thermal energy can be transmitted to the fuel directly by the wall by means of thermal conduction are advantageously reduced. At the same time, the pipe can easily be disposed and centered within the wall. To this end, the pipe in one design embodiment has widened regions, the cross sections thereof having larger external dimensions than other cross sections of the pipe. If the pipe has a circular cross-sectional geometry, the pipe can have a larger external diameter in the contact region than in other regions of the pipe in which no contact region is provided. In another design embodiment, the pipe has constant external dimensions, and the wall is constricted in regions so as to form the contact regions.

The pipe can have at least one branch which is in each case fluidically connected to a rail connector for connecting a pressure vessel. In one preferred design embodiment, the branch comprises an annular gap by way of which the fuel can make its way into the rail connector. At least one contact region can preferably be provided so as to be adjacent to the branch. For thermal insulation, the annular gap can be separated from the at least one gap by at least one contact region, for example. In one particularly preferred design embodiment, the openings through which the fuel makes its way into the at least one gap for thermal insulation are provided in the contact regions. Such a design embodiment is easier and more cost-effective to produce and is particularly functionally reliable. Alternatively or additionally, the insulation can be formed by an insulation coating applied to the inside of the wall.

The fuel line as a common fuel line particularly preferably connects a plurality of pressure vessels. The fuel line can in particular be provided upstream of the (high-pressure) pressure reducer. The fuel line is expediently configured to withstand substantially the same pressure or higher pressures than the pressure vessels that are connected to the fuel rail. The individual pressure vessels of the pressure vessel assembly are fluidically connected directly to one another by way of the fuel line or the fuel rail, respectively so that the individual pressure vessels in the intended state of operation substantially have the same pressure, based on the principle of communicating pipes.

The fuel line can preferably be configured as a fuel rail. The fuel rail can also be referred to as a high-pressure fuel rail. In principle, such a fuel rail can be designed so as to be similar to a high-pressure injection rail of an internal combustion engine. The fuel rail is preferably formed by a single one-piece pipe, or a single one-piece block, or a single housing, respectively. The fuel rail expediently comprises a plurality of rail connectors for connecting directly to the pressure vessels. The individual rail connectors may be advantageously provided directly on the rail housing or block or pipe, respectively, and/or all may have the same mutual spacing. Such a fuel line is disclosed, for example, in German patent applications with the application numbers DE 10 2020 128 607.4 and DE 10 2020 123 037.0, the content thereof in terms of the design embodiment of the fuel rail (also referred to as distributor pipe or rail) and the attachment of the pressure vessels being incorporated herein by reference. Alternatively, the fuel rail can be configured as a metallic block as is disclosed, for example, in publication DE 602017034685 D1.

The fuel rail can be configured so as to be substantially flexurally stiff. Flexurally stiff in this context means that the fuel rail is stiff in terms of bending, or that only bending which is imperceptible and unnoticeable in terms of functioning arises in the use of the fuel rail according to the intended function. In an alternative design embodiment, the fuel rail can be configured in such a manner that the fuel rail can compensate positional variations of the pressure vessels, and in particular of the connector pieces of the latter. Positional variations are variances between an actual position of the pressure vessels (in operation, during production, during maintenance work, or any other situation) and a nominal position assumed in the designed construction. Positional variations are the result of, for example, expansions of the components (e.g., of the pressure vessels) owing to changes in the internal pressure and/or changes in temperature. Furthermore, positional variations (positional variances) owing to manufacturing tolerances can arise. The fuel rail can be specified to enable equalization of tolerances perpendicular to the pressure-vessel longitudinal axes of the pressure vessel system. The fuel line, or the fuel rail, respectively, and typically also the shut-off valve described hereunder, may advantageously be constituent parts of the pressure vessel assembly.

At least one thermally activatable pressure relief device, also referred to as a thermal pressure relief device (TPRD) or thermal fuse, can in each case be provided on each end of the fuel line or directly adjacent to the latter. Adjacent to the end here includes the disposal of the TPRDs at a spacing of at most 0.1×L, where L is the overall length of the fuel rail. A TPRD is typically provided adjacent to the pressure vessel. Under the effect of heat (e.g., by flames), the fuel stored in the pressure vessel is discharged into the environment by the TPRD. The thermal pressure relief device discharges the fuel as soon as the trigger temperature of the TPRD is exceeded (i.e., thermally activated).

An electrically activatable shut-off valve which is closed when not energized can be provided on the pressure vessel assembly or on the fuel line, the shut-off valve being specified to shut off the pressure vessel assembly or the fuel line in relation to the other fuel-conducting lines of the fuel supply system leading to the energy converter. This shut-off valve may have the function of an on-tank valve of a conventional pressure vessel. Only one shut-off valve which is closed when not energized may be expediently provided. The shut-off valve can be able to be screwed directly onto or into the pressure vessel assembly, for example. The (common) shut-off valve may be the first valve which is provided downstream of each one of the pressure vessels connected to the common fuel line.

In the installed position, the pressure vessels are advantageously disposed so as to be substantially between the door sills. Alternatively or additionally, the underfloor chassis on the sides can comprise energy-absorbing crash deformation structures, preferably with lattice structures, which are specified to at least reduce the impact energy that is transmitted to the pressure vessel assembly in the event of a collision.

In other words, the technology disclosed herein relates in particular to a rail for a pressure vessel system. The rail can preferably be formed from metal, in most instances from aluminum. The rail can have a relatively high thermal capacity and a relatively positive thermal conductivity. The rail may be expediently configured for fueling with pre-refrigerated fuel, in particular hydrogen. One aspect of the technology disclosed herein lies in thermally insulating the fueling mass flow of hydrogen from the rail. This could be achieved, for example, by a polymeric material coating on the inside of the long duct in the rail. It can be expediently provided that a pipe, which has a thin wall in comparison to the duct wall, is inserted into a duct as insulation. The pipe can be widened in some regions. The pipe can be fixed within the duct by way of these widenings. A plurality of cross-bores can be provided at each branch to a pressure vessel.

The cross section, in particular the bore diameter, of the duct may expediently be larger than the cross section passed through by the flow of fuel. The internal diameter of the duct, or of the bore, respectively, may expediently be approx. 3 mm to 10 mm. The length of the duct is preferably approx.
50*D to 300*D, or
100*D to 200*D,

where D is the bore diameter of the duct. Such diameters can be produced in a particularly economical manner. The fuel duct may be expediently provided by bores which are incorporated in a block from two opposite end sides. In order not to generate excessive pressure losses, fuel lines with an internal diameter of at least 3 mm can be used.

The duct may be advantageously provided by drilling. The drilling depth may be particularly advantageously at most 1.7 m, or at most 0.9 m, or at most 0.8 m, or at most 0.7 m, or at most 0.6 m. The drilling depth may expediently be 2 cm to 20 cm, or 5 cm to 10 cm, less than the overall length of the block.

The gap toward the duct wall may be 2 mm or less, or 1 mm or less. The duct diameter can expediently be chosen such that the duct for the fuel rail can be produced only from one side. The fuel rail herein has a length between 0.6 m and 2.4 m, or between 1 m and 2 m, or between 1.2 m and 1.8 m.

While fueling takes place, almost the entire mass flow passes through the thin-walled pipe. Stationary hydrogen is located in the gap between the thin-walled pipe and the duct. Hydrogen has a relatively low coefficient of heat conductivity and therefore is a good insulator. The coefficient of heat conductivity at 200 bar and 15° C. is 0.2 W/m/K. The hydrogen flows through the cross-bores of the thin-walled pipe into the annular gap at each branch to a tank. From there, the hydrogen flows into the branch to the tank. An 8-tank system is plotted in FIG. 2. In this case, ⅛ of the fueling mass flow would flow into the first tank, and ⅞ would flow onward in the thin-walled pipe to the downstream tanks. Owing to the thin-walled pipe being a relatively good insulator, the flowing hydrogen is heated to a lesser extent by the rail.

This means that the rail is not fully cooled in the relatively short fueling time of a few minutes. The heat exchanger effect of the rail is also significantly less relevant. The wall thickness of the thin-walled pipe can be relatively minor, or a material with relatively little strength can be used, respectively, because the pressure acting on the inside and the outside is almost identical. The maximum pressure differential between the inside and the outside is equal to the pressure loss in the gas flowing between two tank branches. This pressure loss is typically a few bar.

### BRIEF DESCRIPTION OF THE FIGURES

The technology disclosed herein will now be explained by means of the figures in which:

FIG. 1 shows a schematic view of the pressure vessel system;

FIG. 2 shows a schematic view of the fuel line 200 and of a plurality of pressure vessels 100;

FIG. 3a and FIG. 3b show cross-sectional views along the line A-A of FIG. 2 according to alternative embodiments; and

FIG. 4 shows a schematic view of detail G of FIG. 2.

### DETAILED DESCRIPTION OF THE FIGURES

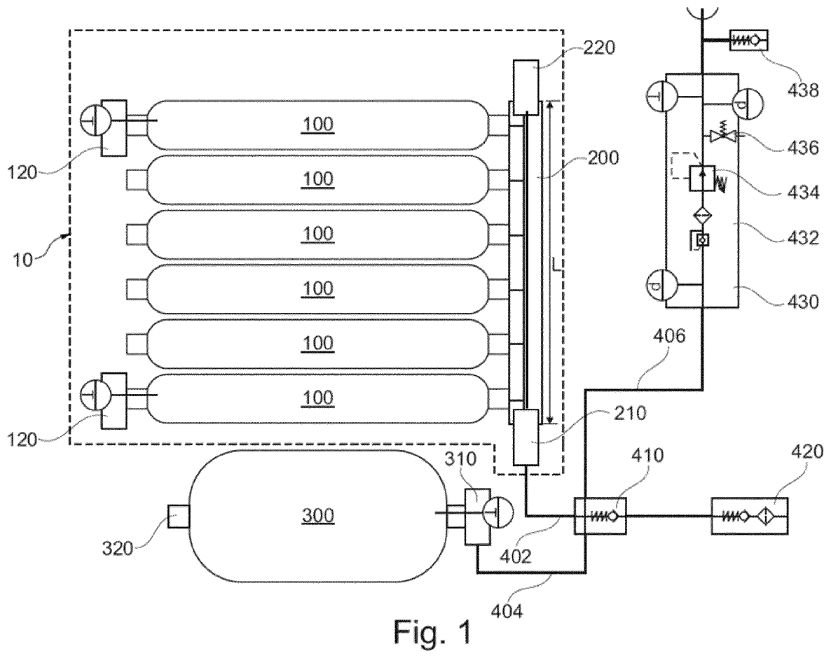

FIG. 1 shows a schematic view of the pressure vessel system of the technology disclosed herein. The filler neck 420 by way of a fuel line is fluidically connected to a distributor unit 410. A non-return valve which is specified to preclude a backflow toward the filler neck 420 can be provided in the distributor unit 410. The distributor unit 410 is fluidically connected to an on-tank valve 310 of the further pressure vessel 300 which can be disposed below the rear seat bench, for example. However, such a further pressure vessel 300 does not have to be provided. A shut-off valve, a temperature sensor, a burst-pipe protection and/or a filter can expediently be provided in the on-tank valve 310 (not shown to some extent here). In a further design embodiment, a TPRD can likewise be provided at the opposite end of the further pressure vessel 300.

A fuel line 406 connects the distributor unit 410 to a pressure reducer unit 430 in which a burst-pipe protection 432, at least one pressure sensor, at least one temperature sensor, a mechanical safety valve 436 as well as a pressure reducer 434 can presently be provided. Furthermore, a service interface 438 which is provided for discharging fuel is presently provided downstream of the pressure reducer 434.

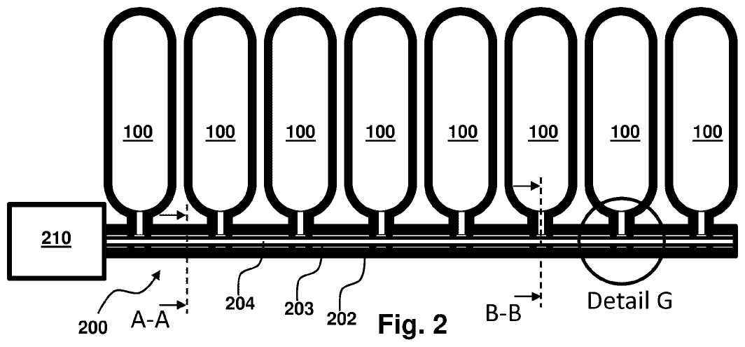

The fuel line 402 connects the distributor unit 410 to the shut-off valve 210. The shut-off valve 210 (cf. FIG. 2) is an electrically activatable shut-off valve which is specified to isolate the fluidic connection of the pressure vessel assembly 10 from the remaining fuel supply system. The fuel line 200 here is configured as a fuel rail. The fuel line 200 is provided in or on the pressure vessel assembly 10. The fuel rail is a line from which rail connectors branch off for fastening the individual pressure vessels 100 (cf. FIG. 2). The fuel line 200 can be embodied as a mechanically stiff fuel rail in such a manner that the fuel rail does not burst even in the event of an intrusion during an accident. Alternatively, a comparatively flexible fuel line which is received in a line housing can be provided. The line housing serves to additionally protect the fuel line 200 in relation to mechanical intrusion. The individual pressure vessels 100 of the pressure vessel assembly 10 are disposed so as to be substantially parallel to one another and identically spaced apart from one another. These pressure vessels 100 here have substantially identical lengths. Depending on the installation space in which the pressure vessel assembly 10 is to be installed, individual pressure vessels 100 of the pressure vessel assembly 10 may differ in length and/or have different diameters. No further electrically activatable shut-off valves are preferably provided between the individual pressure vessels 100 and the fuel line 200 so that the individual pressure vessels 100 of the pressure vessel assembly 10 in the intended use of the pressure vessel system are fluidically connected directly to one another, like communicating pipes. The reference sign L here denotes the overall length of the fuel line 200.

The ends of the pressure vessels 100 that are connected to the fuel line 200 are the proximal ends of the pressure vessels 100. The ends of the pressure vessels 100 that are provided on the opposite side are those ends of the pressure vessels 100 that are distal in terms of the fuel line 120.

One TPRD, and advantageously also one temperature sensor, are in each case advantageously provided on the distal ends of the two outer pressure vessels 100, thus those pressure vessels 100 which in the view from above do not have any further pressure vessel 100 on each side. A TPRD is likewise provided in the housing or block of the shut-off valve 210. A TPRD is furthermore provided on or adjacent to that end of the fuel line that lies opposite the shut-off valve 210. The TPRDs, the sensors and the valves, if disposed locally on the same locations of the pressure vessels 100, or the fuel line 200, respectively, are advantageously provided in common housings or blocks, respectively, so that the number of interfaces to be sealed is advantageously minimized.

In a further design embodiment, it can be provided that the pressure vessel assembly 10 has only one temperature sensor. The only one temperature sensor can preferably be provided in or on or adjacent to the housing of the shut-off valve 210, respectively. In an alternative design embodiment, it can be provided that the sensor is provided on or adjacent to that end of the fuel line that lies opposite the end of the shut-off valve 210, respectively. This has the advantage that the manufacturing costs may be reduced. Furthermore, the interfaces for the TPRDs, provided at the distal ends of the pressure vessels, can therefore be of a smaller design because these interfaces only have the TPRDs and do not also have an additional temperature sensor. This may have an overall advantageous effect on the utilization of the installation space. Also, no electrical lines have to be routed to the distal ends of the pressure vessels. The temperature sensor may be expediently integrated in such a manner that the temperature sensor is specified to record the temperature during fueling as well as during retrieval. If only one pressure vessel assembly without any further pressure vessel (e.g., a rear seat tank) is provided, the pressure sensor from the pressure reducer unit could also be transferred into the housing of the shut-off valve. Advantageously, the pressure sensor may be provided in such a manner that the latter is provided between the fuel line 200 and the shut-off valve 210. In this way, a pressure measurement can be performed even in the event of a closed shut-off valve 210.

The fuel rail, and in particular the wall disposed in the fuel rail, and the thermal insulation may advantageously be configured so as to be substantially straight.

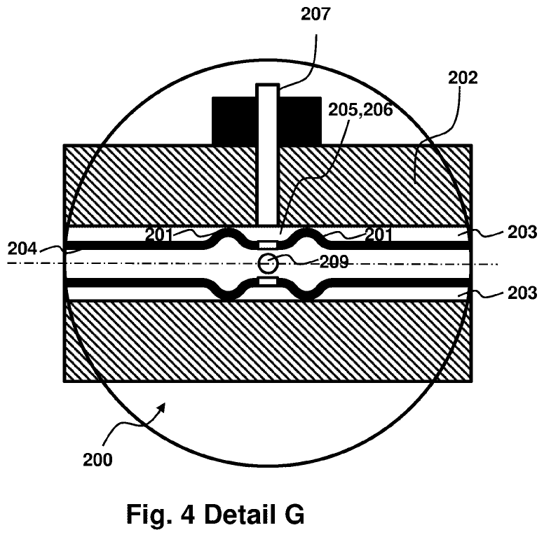

FIG. 2 shows the fuel line 200 and the shut-off valve 210 which is specified to isolate the pressure vessel assembly 10 from the remaining fuel supply system. A burst-pipe protection, a manual valve and/or a TPRD can be additionally provided in the housing of the shut-off valve 210, for example. The fuel line 200, which again is configured as a fuel rail, is fluidically connected to the shut-off valve 210. The fuel line 200 runs in a substantially straight line. A bore is provided in the interior of the fuel line 200. This bore may have been incorporated from one of the end sides. Alternatively, it can be provided that one bore is in each case provided from both end sides of the opposite ends of the fuel line 200, these bores meeting in the center. The at least one bore forms the internal wall of the wall 202 of the fuel line 200. The fuel line 200 here is formed by an aluminum block. This is however not mandatory. The thermal insulation 204 is provided in the interior of the wall 202. The thermal insulation 204 here is conjointly formed by a pipe. The pipe is expediently a polymeric material pipe which is preferably provided so as to be concentric in the wall 202. As can be seen in more detail in FIG. 4, branches 206 which establish fluidic connections to the individual pressure vessels 100 emanate from the insulation 204. A plurality of gaps 203 are provided at least in portions between the pipe and the wall 202.

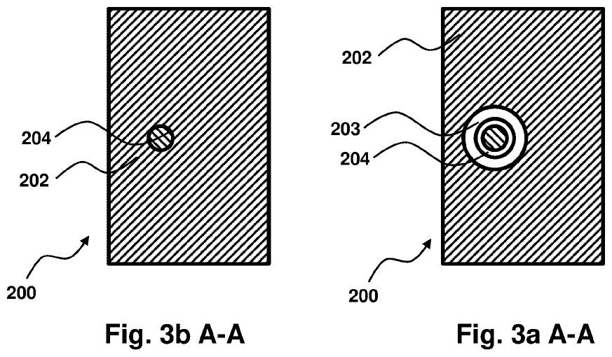

FIG. 3a shows a sectional view A-A of the design embodiment of FIG. 2. It can be readily seen that the insulation 204, which is conjointly formed by the pipe, is configured so as to be spaced apart from the wall 202. The wall 202 here is formed by a metallic block in which a fuel duct has been incorporated. A gap 203 is configured between the pipe and the wall 202. The gap 203 here completely surrounds the pipe. It is apparent that an almost identical flow cross section for transporting the fuel during fueling is formed in comparison to the design embodiment of FIG. 3b, whereas the bore incorporated in the metallic block has a much larger cross section. A bore with such a diameter is easier to produce than the bore which is provided in the design embodiment according to FIG. 3b. This facilitates the production of the fuel line 200.

FIG. 3b shows a sectional view A-A of an alternative design embodiment in which the insulation 204 has been applied by coating. Almost the entire internal cross section of the wall 202 is available here for transporting the fuel during fueling.

FIG. 4 shows a schematic view of detail G of FIG. 2. The rail connector 207 serves for connecting a pressure vessel 100 (not shown). For reasons of simplification, the mechanical connector has been omitted here. The latter could be implemented in any suitable way. The rail connector 207 runs substantially perpendicularly to the direction of main extent of the fuel line 200. The pipe, which conjointly forms the insulation 204, here is again provided so as to be concentric in the interior of the bore provided in the metallic block. The branch 206 here is provided in the region of the rail connector 207. The branch 206 here comprises a plurality of passage openings 209 through which the fuel makes its way into the annular gap 205. Two contact regions 201 are provided here so as to be directly adjacent to the branch. In the contact regions 201, the pipe bears on the internal surface of the wall 202. In comparison to the other regions, e.g., those regions in which a gap 203 is provided, the contact regions 201 have an enlarged external diameter. The contact regions 201 serve for fastening and centering the insulation 204. One gap 203 is in each case shown here between the pipe and the wall 202, in each case adjacent to the contact regions 201. The gap 203 likewise contains fuel. In an expedient design embodiment, it is provided that overflow ducts, which connect the individual gaps 203 to the inner flow cross section of the pipe, are provided in the contact regions 201. The overflow ducts can be configured by grooves in the circumferential faces of the contact regions 201, for example. The fluidic connections to each gap 203 are expediently designed such that these gaps 203 do not form ducts with an intense flow passing through. This can be prevented in that openings or overflow ducts are provided only at one end of a gap. The gaps 203 thus preferably form dead volumes with stationary fuel. Such a design embodiment results in that each gap 203 transfers the heat from the atmosphere to the fuel only comparatively ineffectively. The flow rate of the fuel in the interior of the pipe of the insulation 204 during fueling is many times higher than the flow rate in the gap 203. In this way, an overall poorer thermal transfer from the fuel to the environment can be implemented, so that fuel which is heated to a lesser extent flows into the pressure vessel 100 that is distal in terms of the shut-off valve 210. In this way, an overall more uniform fuel temperature in the pressure vessels 100 can be achieved.

The term “substantially” (e.g., “pressure vessels disposed substantially in parallel”) in the context of the technology disclosed herein comprises in each case the exact property or the exact value (e.g., “pressure vessels disposed in parallel”) as well as variances which are in each case insignificant in terms of the function of the property/the value (e.g., “tolerable variance from pressure vessels disposed in parallel”).

The above description of the present invention serves only for illustrative purposes and not for the purpose of limiting the invention. Various variations and modifications are possible within the context of the invention without departing from the scope of the invention and its equivalents.

1-14. (canceled)

15. A fuel line for a pressure vessel system of a motor vehicle, the fuel line comprising:
a wall; and
thermal insulation provided in an interior of the wall,
wherein the wall is configured to compensate mechanical loads resulting from internal pressure prevalent in the fuel line.

16. The fuel line according to claim 15, wherein at least one pipe at least conjointly forms the thermal insulation.

17. The fuel line according to claim 15, wherein a wall thickness of the thermal insulation is less than a wall thickness of the wall by a factor of at least 2.

18. The fuel line according to claim 17, wherein the factor is at least 5.

19. The fuel line according to claim 18, wherein the factor is at least 10.

20. The fuel line according to claim 16, wherein at least one gap is provided at least in regions between the wall and the at least one pipe.

21. The fuel line according to claim 20, wherein the at least one pipe is permeable to fuel at least in regions, whereby pressure in the at least one gap and pressure in an interior region of the at least one pipe at least approximate one another.

22. The fuel line according to claim 20, wherein the at least one pipe has at least one contact region in which the at least one pipe bears on the wall, and in other regions is spaced apart from the wall by the at least one gap.

23. The fuel line according to claim 20, wherein, during fueling, a flow rate of the fuel in the at least one gap is lower than in an interior region of the at least one pipe by a factor of at least 10.

24. The fuel line according to claim 23, wherein the factor is at least 100.

25. The fuel line according to claim 24, wherein the factor is at least 1000.

26. The fuel line according to claim 16, wherein the at least one pipe has at least one branch which is in each case fluidically connected to a rail connector for connecting a pressure vessel.

27. The fuel line according to claim 26, wherein at least one contact region is provided so as to be adjacent to the at least one branch.

28. The fuel line according to claim 16, wherein the at least one pipe is configured to be insertable into the interior of the wall.

29. The fuel line according to claim 15, wherein the insulation comprises an insulation coating applied to an inside of the wall.

30. The fuel line according to claim 15, wherein the wall comprises a metallic block in which at least one fuel duct is incorporated.

31. A pressure vessel system for storing fuel, the pressure vessel system comprising:
a pressure vessel assembly comprising a plurality of pressure vessels fluidically connected to one another by the fuel line of claim 15,
wherein the pressure vessels in an installed position are disposed substantially parallel to one another.

32. The pressure vessel system according to claim 31, wherein the fuel line is configured as a fuel rail, and
wherein a shut-off valve is provided on the fuel line, and
wherein the pressure vessels of the pressure vessel assembly are configured as communicating pipes.

33. The pressure vessel system according to claim 32, wherein no electrically activatable shut-off valves are provided between the pressure vessels and the fuel line.
